(19) United States
(12) Patent Application Publication
(10) Pub. No.: US 2002/0059397 A1
(43) Pub. Date: May 16, 2002

(54) Content operating system

(75) Inventors: Christopher J. Feola, Grapevine, TX (US); James C. Jennings IV, Dallas, TX (US)

Correspondence Address: Gary B. Solomon, Jenkens & Gilchrist, P.C., 3200 Fountain Place, 1445 Ross Avenue, Dallas, TX, 75202-2799, US

(73) Assignee: The Belo Company,

(21) Appl. No.: 10/008,491

(22) Filed: Nov. 13, 2001

Related U.S. Application Data
(60) Provisional application No. 60/248,171, filed on Nov. 13, 2000.

(51) Int. Cl. G06F 15/16

(52) U.S. Cl. 709/217; 709/246

(57) ABSTRACT

A system and method for distributing content over a distribution channel of a network. The method may include receiving the content to be distributed over the distribution channel of the network. At least one rule may be applied to the content, where the rule(s) may be based on the distribution channel for the content to be distributed. The content having the rule(s) applied thereto may be communicated to have at least one data element further applied thereto via a distinct process from the applying of the rule(s). The content may thereafter be prepared for distribution over the distribution channel.

### RELATED CASES

This application claims priority from co-pending U.S. patent application Ser. No. 60/248,171 (Attorney Docket 45003-45USPL) filed Nov. 13, 2000 and 09/905,406 (Attorney Docket 45003-31USPT) filed Jul. 13, 2001, which are incorporated herein by reference.

### BACKGROUND OF THE PRESENT INVENTION

1. Field of the Invention

The present invention relates generally to data distribution systems, and more specifically, a content operating system.

2. Background of the Invention

Publishers or content providers of information, such as newspapers publishers, have long faced the challenge of having to collect, organize, maintain, and distribute the information efficiently and cost effectively. There are basically three categories that define a content system that publishers use, including: (i) production systems, (ii) content management systems, and (iii) content operating systems. In terms of production systems, computers and publishing software revolutionized the publishing industry in terms of being able to produce a document in a more product line style that is faster and easier than hand-processing text and graphics on a layout board. Other difficulties, however, developed as the publishers found that management of the information on the computers became important for historical and repurposing or reuse reasons. Content management systems have become important tools for providing archiving capabilities.

Traditional publishing also evolved with the advent of a variety of distribution media. No longer do content providers simply produce a paper output of the content. Today, content providers face a wide-range of distribution channels and terminals or devices that access and output (i.e., display) the content. The distribution channels may include the Internet, wireless, and satellite networks, and the devices may include televisions, computers with monitors, hand-held devices, such as personal digital assistance (PDA), mobile telephones, etc. As technology continues to develop, distribution channels and devices will undoubtedly continue to develop and change.

In order to distribute the content for distribution over the distribution channel to the devices, the content provider has traditionally prepared the content to be accommodated by the distribution channel and the device to display the information toward a consumer, for example. In the case of distributing a news story originally prepared for publication on a traditional newspaper over a wireless network to an Internet enabled mobile phone, the news story and associated photographs are significantly altered prior to distribution due to bandwidth concerns of the wireless network and screen size limitations of the mobile phone. And, in the case of multiple distribution channels and devices, the multiple versions of the content may be generated by a production system and maintained by a content management system.

Existing content distribution systems have been designed with limited expansion capability. For example, the television broadcast industry uses content distribution systems that have multiple aspects of packaging the content for distribution over a distribution channel located in a single hardware equipment. If any change is made in the distribution channel, such as increasing the bandwidth or applying a different modulation scheme, massive changes of the system is necessary.

### SUMMARY OF THE INVENTION

To overcome the problems of having to hand-craft content for different distribution channels and terminals, a content operating system having object oriented properties allows for a content provider to publish the content to a variety of distribution channels and terminals without having to modify the content. By utilizing object oriented or modular architecture, objects may be combined in any fashion, thereby allowing the content operating system to be infinitely modified without rebuilding. Additionally, the content operating system may be modified easily upon a distribution channel being altered or a new terminal becoming available, for example. And, the objects may reside and operate outside the confines of a particular publishing system, thereby allowing the objects to be broadcast onto a “network cloud” to operate within a variety of devices, including infrastructure (e.g., servers) and terminals (e.g., hand-held wireless devices).

One embodiment may include a system and method for distributing content over a distribution channel of a network. The method may include receiving the content to be distributed over the distribution channel of the network. At least one rule may be applied to the content, where the rule(s) may be based on the distribution channel for the content to be distributed. The content having the rule(s) applied thereto may be communicated to have at least one data element further applied thereto via a distinct process from the applying of the rule(s). The content may thereafter be prepared for distribution over the distribution channel

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an exemplary block diagram representative of a content operating system for distributing content according to the principles of the present invention;

FIG. 2 is another exemplary embodiment of the content operating system of FIG. 1 having a different architecture;

FIG. 3 is an exemplary system block diagram of a network for operating the content operating systems of FIGS. 1 and 2;

FIG. 4 is an exemplary flow diagram for operation of the content operating systems of FIGS. 1 and 2; and

FIG. 5 is another exemplary flow diagram for operation of the content operating system of FIGS. 1 and 2.

### DETAILED DESCRIPTION OF THE DRAWINGS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

There are generally three aspects of content systems that publishers or content providers utilize, including: (i) production systems, (ii) content management systems, and (iii) content operating systems. A content operating system may be considered a distribution system for content produced by the production and content management systems. Traditionally, content operating systems have had limited scope of functionality as distribution channels and devices or terminals have been limited in diversity. The traditional distribution channels include print media, radio, and television. Designers of the distribution systems, therefore, designed the systems with a single distribution channel and terminal in mind. In other words, content distributed from the distribution systems was singularly purposed; content for newspaper was prepared and distributed different than content for television.

Enter the digital age. With the creation of the Internet, wireless networks, and satellite networks, content distribution now has many distribution channels and terminals to be directed. Designers of the distribution systems, however, have continued to design the distribution systems with limited purpose architectures, thereby mandating that content providers continue the hand-craft process of formatting content for each distribution channel and terminal.

One reason that distribution systems are designed with limited purpose architectures is that, traditionally, the channel and terminal are known, and multiple facets of the distribution system are intermeshed to the point that altering the system generally requires a complete redesign. Additionally, distribution systems are designed to conform to the legacy production and management systems.

The principals of the present invention are directed to separating the various aspects of the content distribution system into distinct components or objects. By separating the various aspects into distinct objects in an object oriented framework, the content may be produced once and remain the same or substantially the same for multiple channels and terminals. Additionally, utilizing an object oriented framework, the distribution system may be easily maintained and reconfigured upon a distribution channel being upgraded or new terminals being developed, for example. The objects may be placed in the “network cloud”, including operating in network infrastructure (e.g., servers) and terminals (e.g., mobile phones). The objects may thereafter function to process and distribute the content on an as-needed or availability basis.

In one embodiment, the distinct objects include: (i) content objects, (ii) rule objects, (iii) container objects, and (iv) channel objects. Another embodiment may include object brokers and directory lookup services for distributing process resources for content distribution.

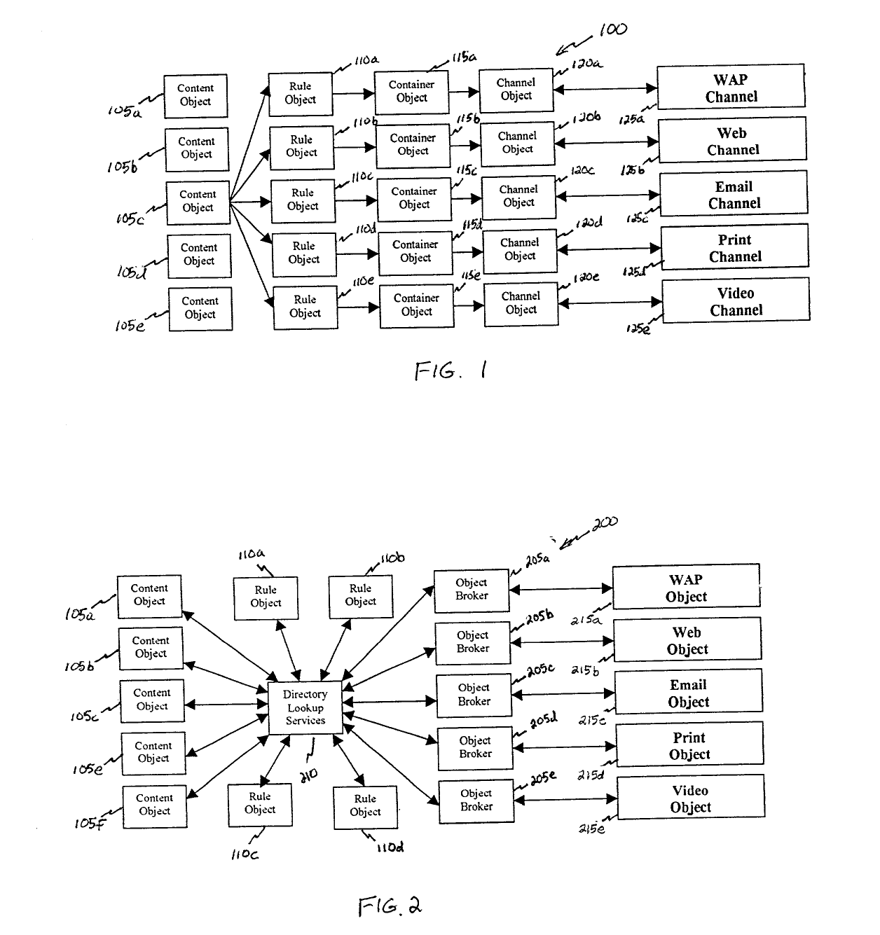

FIG. 1 is an exemplary content operating or distribution system 100 that operates in accordance with the principles of the present invention. Various aspects of the system have been separated into distinct objects, including: (i) content objects 105a-105e (collectively 105), (ii) rule objects 110a-110e (collectively 110), (iii) container objects 115a-115e (collectively 115) and channel objects 120a-120e (collectively 120). As shown, the content object 105c may be a news story having text and image data produced by a news content provider. The content object 105c may be produced by the news content provider without regard to a particular channel. Generally, however, the content object 105c is developed for a distribution channel and terminal having the highest bandwidth and resolution, respectively, as data is more easily removed than added from an image.

Rule objects 110, which provide the rules that the content objects are subject to, may be utilized to prepare or alter the content objects 105 based on the particular channel and/or terminal for which the content object 105 is destined. For example, if a content object 105 containing a news story is distributed to a personal computer via the web, the content object 105 follows a web rule for channel distribution and a personal computer rule for terminal display. Or, if a content object 105 containing a photograph is sent to an e-mail address, the content object 105 follows an e-mail rule for a distribution channel and a personal computer rule for a terminal display.

A container object 115, which may be considered a content object container, may be an object version of what are sometimes called templates. To follow the previous example, if a content object 105c is composed of text, the rule object 110b having web rules is followed. The rule object 110b may know which content container object 115b to call to make it look like a particular publisher's environment (e.g., Morning News page). In other words, the rule object 110b knows what the rules are for the channel and terminal to which the content object 105c is to be displayed. Additionally, the rule object 110b knows into which display container 115b that the content object lO5c is to flow. It should be understood that the rules for a wireless network distribution channel to a mobile phone or pager terminal are different than those for the internet to a personal computer.

The channel object 120 may be a channel or a way of sending the content object 105c via a container object 115b to whatever channel 125b the content object is destined—whether that channel 125 be WAP 125a, web 125b, e-mail 125c, print 125d, or video 125e, for example. It should be understood that other channels 125 may be utilized or that new channels may be added. While the structure shown is linear (i.e., one rule 110, container 115, and channel 120 object per channel), it should further be understood that there may be many rule objects 110 per channel 125 and provided in a variety of different configurations. Whether a database (not shown) or an independent object oriented system is utilized for storing the data published and maintained by a content management system, the basic concept according to the principles of the present invention is that a separate content object for each piece of data may exist. Alternatively, multiple pieces of associated data (e.g., news story and associated photograph) may be included in a single content object 105.

Pragmatically, once the content is edited, the rule objects 110 allow different distribution of that content without having to hand-edit each content object 105 for different distribution channels and/or terminals. If, for example, an editor says, “Okay, I'm going to send this news story to the website to be viewed by personal computers.”, the distribution of the news story happens automatically by formatting the news story in the form of a content object 105c, transmitting the content object to the appropriate rule object 110b, applying the appropriate container object 115b, and communicating the packaged content object 105c via the channel object 120b to the web channel 125b. The web rule 110b knows what container object 115b is needed for any particular website utilizing the web rules.

The distribution aspect and operation of the content operating system 100 may be as automatic as the rule objects 110 may be defined. For example, if a change to the “look” of a distribution medium is necessary (e.g., if a web publisher's template is to change), the rule object 110 and/or container object 115 simply needs to change accordingly. The editor of the content does not have to know anything external to the creation of the content object 105, and the editor may continue to publish the content as before. Accordingly, the content continues to be properly distributed. Essentially, the distribution of the content operates as a “black box” from the editor's point-of-view.

In one embodiment, a video clip may be requested by and destined for a hand-held device, such as a PDA. One rule object 110 may include a rule, “streaming video onto a cellular channel to be viewed by PDA devices requires a reduction of the video from X frames and Y pixels/inch to be X′ frames and Y′ pixels/inch”. The rule may be applied in a number of different ways as understood in the art. The rule object 110 may further contain a whole set of rules for the kind of presentation terminal that the content object 105 ultimately is displayed. Another rule object 110 may contain a set of rules for a video channel, such as high-definition television (HDTV), that requires high resolution and high frame rates. The bottom line is that the rule objects 110 may define the processes for which the content objects 115 are subject to in order to properly distribute and present the content contained in the content object 105.

The container object 115 may include a set of display or presentation rules or processes for a particular channel 125. For example, a container object 115b for the web may contain a set of extensible stylesheet language (XSL) or hypertext markup language (HTML) templates, as understood in the art, so that advertisements, for example, and other components may be pieced together by the rules based on the particular set of rules. Whether the set of rules are for news website or the Federal Aviation Administration website, because each of these templates are kept in a separate set of container objects 115, the story itself need not be re-edited for each website as each template is predetermined. Additionally, for any distribution channel (e.g., news website, federal organization website, e-mail, WAP, print, etc.) the same story may be sent using different rule sets and be properly distributed to a particular distribution channel 125.

The channel object 120 may be basically a way of hooking together the database or system on the content production side to the output or distribution system (e.g., HTTP engine, SMTP engine, WML to WAP channel). It should be understood that the channel object 120 may include hardware and/or software for processing and distributing the content as understood in the art.

FIG. 2 is another exemplary embodiment of a content operating system 200 having a different architecture from the content operating system 100. While the results of the different architectures may be substantially the same, the architecture of the content operating system 200 allows for a more distributed architecture. As shown, the content objects 105 may be the same and the rule objects 110 may be the same. However, standard high end object services are included that content management systems generally do not include. In particular, content management systems generally make use of present distribution standards to negotiate for entry into the network processing. Object brokers 205a-205e (collectively 205) for directory lookup services 210 may be part of common object request broker architecture (CORBA) Genie, or other known object technologies. The object broker 205 may negotiate between a client (not shown) and a distribution object 215a-215e (collectively 215)—an abstraction layer that allows a WAP phone or an e-mail client to talk to a set of objects without having to know the rules for the objects.

A CORBA point may be initially set up and the objects (e.g., content 105, rule 110, container 115, etc.) may be CORBA compliant. The client should be CORBA compliant so that the CORBA objects basically negotiate between the client and the objects. The directory lookup service 210 may operate as a self-negotiating object architecture, which basically dictates that in a self-negotiating object network, a directory exists where objects are self-registered. For example, a rule object 110a may make itself known to the directory look-up service 210, which then allows clients to request the rule object 110a for processing a content object 105. The directory simply has a list of objects that exist and are currently operating. The directory lookup service 210 may provide for a distributed network of objects available to perform processing in a dynamic manner based on availability of resources operating the objects. It should be understood that the directory lookup services may be centrally located or distributed to handle requests from clients and object brokers 205 to process and distribute the content objects 105 over a variety of different distribution channels to a variety of terminals.

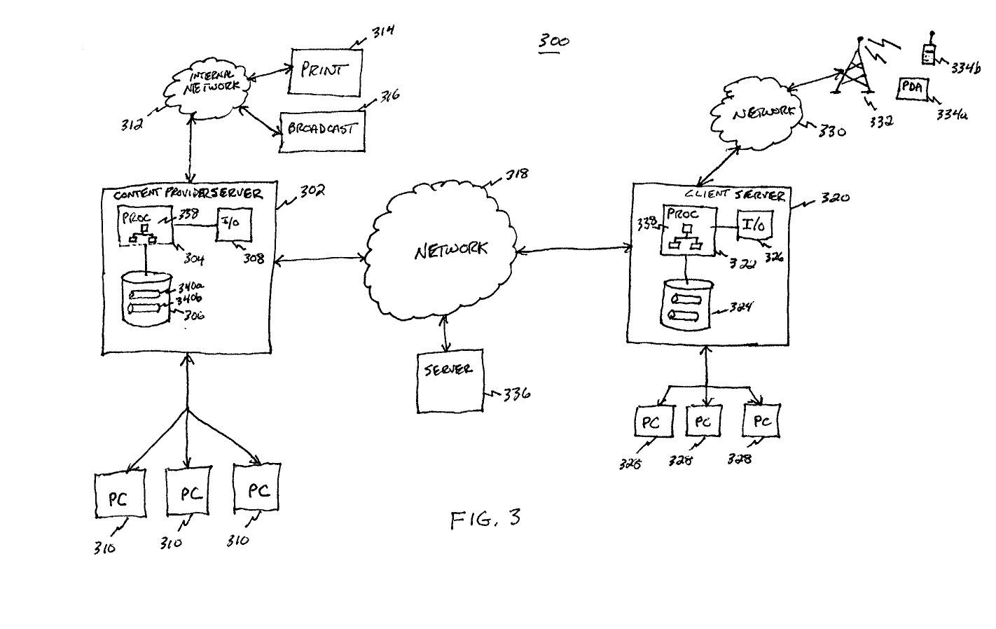

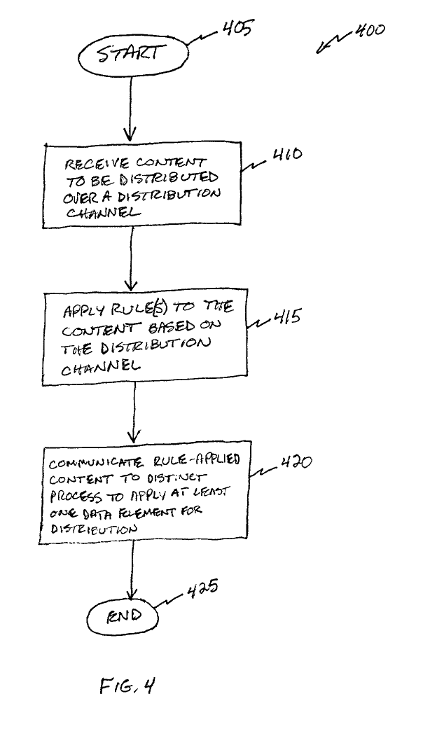

FIG. 3 is an exemplary system block diagram 300 of a network for operating the content operating systems of FIGS. 1 and 2. As shown, a content provider server 302 includes a processor 304, data storage device 306, and input/output device 308. Coupled to the content provider server 302 are personal computers 310 that are used to generate the content. Additionally, other peripherals, such as scanners, audio recorders, etc., may be utilized to create the content. The content provider server 302 may be coupled to an internal network 312, such as a local area network, within the control of the content provider. The internal network 312 may coupled to print (e.g.,newspaper) 314 and broadcast (e.g., television, radio) 316 media.

The content provider server 302 may additionally be coupled to a network 318, such as the Internet or satellite network. Coupled to the network 318 may be a client or distribution server 320 that includes a processor 322, storage device 324, and input/output device 326. The client server 320 may further be coupled to personal computers 328 and a network 330. A transmitter tower 332 may provide communication services to wireless devices 334a and 334b, PDA and mobile telephone, respectively. Other servers 336 may additionally be coupled to the network 318.

In operation, the processor 304 of the content provider server 302 may be utilized to generate content objects 105 using software 338. The content objects 105 may be stored in object oriented databases 340a and 340b based on the different types of content, for example. Commercial database management software as known in the art may be utilized to maintain the databases 340. It should be understood that more than one processor may be utilized by the content provider server 302 to process the content. Alternatively, the personal computers 310 may utilize software to create the content objects 105.

In accordance with the principles of the present invention, once the content objects 105 are generated, the content objects may be published onto the “network cloud”. In one embodiment, the rule 110, container 115, and channel 120 objects may be located and externally executed in the content provider server 302, possibly on the processor 358, or, alternatively, may be located and executed external from the content provider server 302. The rule objects may be located in servers supporting the print 314 or broadcast 316 media. In the case of the content objects 105 being distributed across the network 318, software 338 operating in the processor 322 of the client server 320 may perform none, some, or all of the rule 105, container 115, and channel 120 object processing. Essentially, the processing of the content objects 105 to produce content that may be communicated to different channels and/or terminals may be performed utilizing processing resources anywhere along the network in a modular fashion. In other words, because the functionality of the processing is modular (e.g., content, rules, and containers are separate), the processing of these functions, too, may be performed separately.

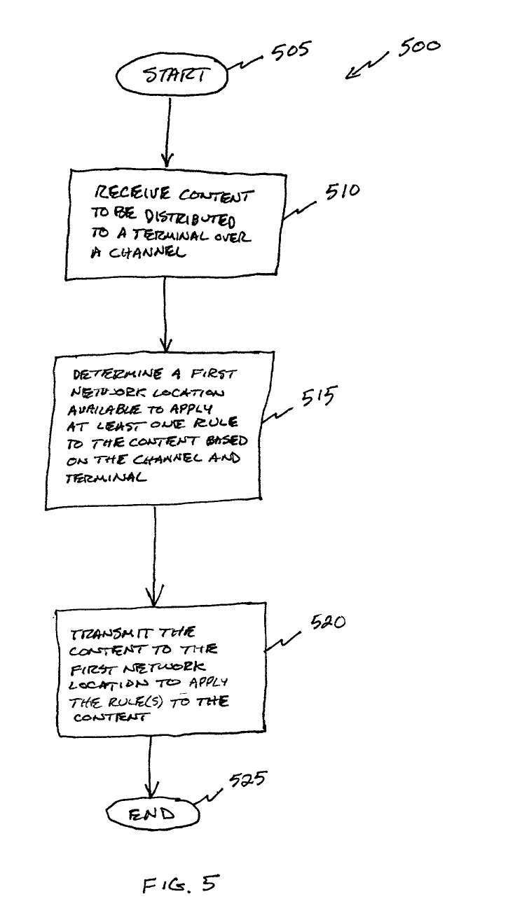

FIG. 4 is an exemplary flow diagram 400 for operation of the content operating systems 100 and 200. The process starts at step 405. At step 410, content to be distributed over a distribution channel is received. At least one rule may be applied to the content based on the distribution channel. The content having the rule(s) applied thereto may be communicated to a distinct process to apply data element(s) for distribution of the content to the distribution channel. The distribution channel may include email, broadcast (e.g., television, radio), ethernet, wireless ethernet, wireless, mobile, and the Internet, for example. The data element(s) may include a template for the content to be displayed or output. The content may include text, graphics, image, video, and audio, for example. The process may further include looking-up a network location to locate processing resources for applying the rule(s).

FIG. 5 is another exemplary flow diagram 500 for operation of the content operating system of FIGS. 1 and 2. The process starts at step 505. At step 510, content to be distributed to a terminal over a channel is received. The content may be in the form of a content object 105. At step 515, a first network location available to apply at least one rule to the content based on the channel and terminal is determined. At step 520, the content is transmitted to the first network location to apply the rule(s) to the content. The process ends at step 525. The process, in essence, utilizes the CORBA model for processing the content utilizing available processing on a network.

The previous description is of a preferred embodiment for implementing the invention, and the scope of the invention should not necessarily be limited by this description. The scope of the present invention is instead defined by the following claims.

What is claimed is:

1. A system for distributing content over a network, said system comprising:
a content object including the content to be distributed over the network;
at least one rule object operable to apply at least one rule to said content object for distribution over the network; and
at least one container object operable to receive and prepare said content object having the at least one rule applied thereto for distribution over the network.

2. The system according to claim 1 wherein the network includes at least one of the following:
terrestrial and satellite based.

3. The system according to claim 1, wherein the network is the Internet.

4. The system according to claim 1, wherein said content object includes at least one of the following:
text, graphics, image, video and sound.

5. The system according to claim 1, wherein each rule object includes at least one rule distinct from other rule objects.

6. The system according to claim 5, wherein the at least one distinct rule is based on a specific channel for which the associated rule object is associated.

7. The system according to claim 5, wherein the at least one distinct rule is based on a specific terminal for which the associated rule object is associated.

8. The system according to claim 5, further comprising a channel object operable to receive said content object as prepared by said container object.

9. The system according to claim 8, wherein said channel object defines a channel of distribution over the network.

10. The system according to claim 8, wherein said channel object includes at least one of the following channels:
Internet, wireless, cellular, and satellite.

11. The system according to claim 8, wherein the at least one rule defines a process for which said content object is subject to for distribution over a particular channel over the network.

12. The system according to claim 11, wherein the process includes reducing the amount of data to be distributed.

13. The system according to claim 11, wherein the particular channel is predetermined.

14. The system according to claim 8, further comprising a directory lookup service for assigning said content object to at least one rule and at least one container object.

15. The system according to claim 9, further comprising an object broker.

16. The system according to claim 8, wherein the preparation by the at least one container object includes applying a template to said content object for display.

17. A method for distributing content over a distribution channel of a network, said method comprising:
receiving the content to be distributed over the distribution channel of the network;
applying at least one rule to the content, the at least one rule being based on the distribution channel for the content to be distributed; and
communicating the content having the at least one rule applied thereto to have at least one data element further applied thereto via a distinct process from said applying of the at least one rule, the content having the at least one rule and data element being applied thereto being prepared for distribution over the distribution channel.

18. The method according to claim 17, further comprising distributing the content having the at least one rule and data element being applied thereto over the distribution channel of the network.

19. The method according to claim 18, wherein the distribution channel includes at least one of the following:
email, broadcast, ethernet, wireless ethernet, cellular, and the Internet.

20. The method according to claim 17, wherein the network is at least one of terrestrial and satellite based.

21. The method according to claim 17, wherein the at least one data element includes a template for the content.

22. The method according to claim 17, wherein the content includes at least one of the following:
text, graphics, image, video, and audio.

23. The method according to claim 17, further comprising looking-up a network location for processing said applying the at least one rule.

24. A system for distributing content over a distribution channel of a network, said method comprising:
means for receiving the content to be distributed over the distribution channel of the network;
means for applying at least one rule to the content, the at least one rule being based on the distribution channel for the content to be distributed; and
means for communicating the content having the at least one rule applied thereto to have at least one data element further applied thereto via a distinct process from said applying of the at least one rule, the content having the at least one rule and data element being applied thereto being prepared for distribution over the distribution channel.

25. A computer-readable medium having stored thereon sequences of instructions, the sequences of instructions including instructions, when executed by a processor, causes the processor to:
receive the content to be distributed over the distribution channel of the network;
apply at least one rule to the content, the at least one rule being based on the distribution channel for the content to be distributed; and
communicate the content having the at least one rule applied thereto to have at least one data element further applied thereto via a distinct process from said applying of the at least one rule, the content having the at least one rule and data element being applied thereto being prepared for distribution over the distribution channel.

26. A method for distributing content to a terminal operating on a channel, said method comprising:
receiving the content to be distributed to the terminal over the channel;
determining a first network location available to process the content for distribution on the channel, the processing including applying at least one rule to be applied to the content based on the terminal and channel for the content to be distributed; and
transmitting the content to the first network location to process the content for distribution over the channel to the terminal.

27. The method according to claim 26, further comprising:
determining a second network location available to apply at least one data element indicative of a template for the content to be associated.

28. The method according to claim 26, wherein the channel includes at least one of terrestrial and satellite based.

29. The method according to claim 26, wherein the terminal includes at least one of the following:
computing system, mobile telephone, personal digital assistant, and pager.

30. A system for distributing content to a terminal operating on a channel, said system comprising:
means for receiving the content to be distributed to the terminal over the channel;
means for determining a first network location available to process the content for distribution on the channel, the processing including applying at least one rule to be applied to the content based on the terminal and channel for the content to be distributed; and
19. means for transmitting the content to the first network location to process the content for distribution over the channel to the terminal.

31. The system according to claim 30, further comprising:
means for determining a second network location available to apply at least one data element indicative of a template for the content to be associated.

32. A system for distributing content to a terminal operating on a channel, said system comprising:
a processor operable to determine a first network location available to process the content for distribution on the channel, the processing including applying at least one rule to be applied to the content based on the terminal and channel for the content to be distributed.

33. The system according to claim 32, wherein the channel includes at least one of terrestrial and satellite.

34. The system according to claim 32, wherein the terminal includes at least one of the following:
computing system, mobile telephone, personal digital assistant, and pager.
